(19) United States
(12) Patent Application Publication
(10) Pub. No.: US 2026/0352929 A1
(43) Pub. Date: Nov. 5, 2026

(54) Systems and Methods for Dynamically Streaming Three-Dimensional Assets of a Scene Using Different Encoding Formats

(71) Applicant: Illuscio, Inc., Culver City, CA (US)

(72) Inventor: Joseph Nordling, Roeland Park, KS (US)

(73) Assignee: Illuscio, Inc., Culver City, CA (US)

(21) Appl. No.: 19/195,855

(22) Filed: May 1, 2025

(51) Int. Cl. H04N 21/81; G06T 15/00; H04N 21/234

(52) U.S. Cl. CPC H04N 21/8146; G06T 15/005; H04N 21/234

(57) ABSTRACT

A dynamic streaming system and associated methods are provided for streaming three-dimensional (3D) assets of a scene using different encoding formats. The system receives a request for 3D content, and determines one or more of a depth, position, or size for each 3D asset that forms a different part of the 3D content. The system encodes a first 3D asset in a first encoding format and a second 3D asset in a different second encoding format based on the depth, position, or size of the first 3D asset differing from the depth, position, or size of the second 3D asset in the 3D content or a field-of-view from which the 3D content is requested and presented. The system streams the first 3D asset encoded in the first encoding format and the second 3D asset in the second encoding format in response to the request.

### BACKGROUND

The quality of content that is streamed over a data network is constrained by the bandwidth or available resources of the data network. The data network constraints are even more limiting for large size content such as three-dimensional (3D) content. 3D content may be downgraded to a lower resolution or fidelity such that the total amount of data that is streamed from a server to a client is reduced to match the data network limitations and permit the 3D content to be streamed in real-time without buffering or at a desired frame rate. For instance, a 3D mesh model may be initially defined with 10,000 meshes. The total data associated with the 10,000 meshes may prevent a real-time streaming or may introduce buffering when streaming the 3D mesh model over a particular data network. The server may lower the resolution or fidelity of the 3D mesh model by redefining the 3D mesh model with a smaller quantity of larger-sized meshes (e.g., 5,000 meshes). By using fewer meshes, some of the detail in the 3D mesh model is lost. However, the lower resolution or fidelity 3D mesh model may reduce the total size or amount of data of the 3D mesh model so that it may be streamed in real-time without buffering to a client.

In many cases, the 3D content may include multiple different 3D assets that collectively form a 3D scene. A uniform downscaling or upscaling of the 3D assets may cause the 3D content to lose a sense of realism or dimensionality, thereby degrading the overall 3D experience. For instance, equally reducing the fidelity or quality of 3D assets in the background and the foreground may cause the entire 3D scene to appear unrealistic and blurry. Moreover, 3D assets that are defined according to a single 3D format (e.g., a mesh model) may be downscaled or upscaled to a certain point before the 3D asset becomes grossly distorted or gains no noticeable improvement in resolution or quality and the change in the data size may be disproportionate relative to the changes in the resolution or quality as resolutions or quality are changed beyond optimal resolutions or quality settings of the encoding format.

### BRIEF DESCRIPTION OF THE DRAWINGS

FIG. 1 illustrates an example of dynamic streaming of different three-dimensional (3D) assets in the same scene using different encoding formats in accordance with some embodiments presented herein.

FIG. 2 illustrates an example of different depths in a 3D scene for selecting and streaming 3D assets in different encoding formats in accordance with some embodiments presented herein.

FIG. 3 illustrates an example of associating different positions in a 3D scene with different encoding formats in accordance with some embodiments presented herein.

FIG. 4 illustrates an example of the different sizes of occupied areas in a 3D scene for selecting and streaming 3D assets in different encoding formats in accordance with some embodiments presented herein.

FIG. 5 illustrates an example of dynamically adjusting the encoding format at which a 3D asset is streamed based on changes to the 3D asset in a field-of-view in accordance with some embodiments presented herein.

FIG. 6 presents a process for dynamically streaming 3D assets using different formats based on network performance and 3D asset placement in the field-of-view in accordance with some embodiments presented herein.

FIG. 7 illustrates an example of dynamically adjusting the streaming format for 3D assets based on the rendering performance of a requesting client device in accordance with some embodiments presented herein.

FIG. 8 illustrates an example for dynamic lighting of a scene that is generated from 3D assets encoded in different encoding formats in accordance with some embodiments presented herein.

FIG. 9 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and associated methods for dynamically streaming three-dimensional (3D) assets of a scene using different encoding formats. Each of the different encoding formats is optimized to generate a different range of resolutions or fidelities for a 3D asset at a reduced size relative to other encoding formats at the same range of resolutions or fidelities. As the quality or fidelity of the 3D asset is upscaled or downscaled past the optimal range of resolutions or fidelities, it becomes more efficient (e.g., less data is consumed) to encode the 3D asset using a different encoding format.

The dynamic streaming includes streaming different 3D assets that make up the scene or a frame of dynamic 3D content as a mix of two-dimensional (2D) images, 3D mesh models, 3D splat representations, point clouds, and/or other encoding formats depending on the depth, positioning, and/or size of the different 3D assets in the scene. The selection of the different encoding formats for the streamed 3D assets may also be based on available streaming resources or network performance as well as the recipient device's rendering performance.

The dynamic streaming prioritizes streaming the 3D assets in the foreground, at the center, and/or that occupy a large area of the scene using a highest-quality encoding format (e.g., point clouds) and using progressively lower encoding formats (e.g., 3D splat representations then 3D mesh models then 2D images) for the 3D assets that are further from the foreground or the center or that occupy progressively smaller areas of the scene when network performance is low or network resources are limited. As network performance improves or network resources increase so too does the fidelity or quality of the 3D assets as more of the 3D assets may be streamed using the higher quality encoding formats.

The dynamic streaming of the 3D assets in the different 3D formats increases the options for encoding the 3D assets at the different resolutions or fidelities to fit within the available network performance envelope (e.g., bandwidth) and/or client device rendering performance envelope. Accordingly, the dynamic streaming system may stream the 3D assets with higher quality or fidelity and with greater data reduction in response to available network resources or constraints than when streaming the same 3D assets in a single encoding format.

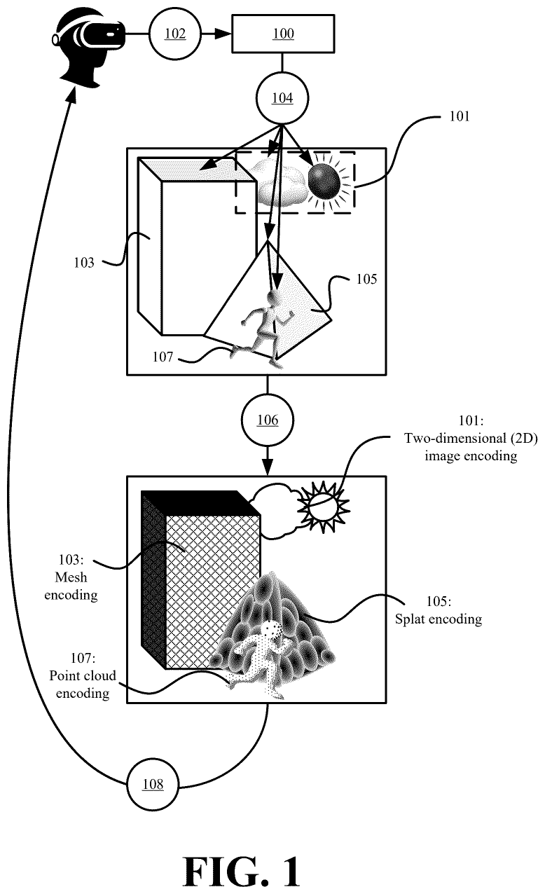

FIG. 1 illustrates an example of the dynamic streaming of different 3D assets in the same scene using different encoding formats in accordance with some embodiments presented herein. Dynamic streaming system 100 receives (at 102) a request for 3D content from a client device. The request may specify the render position for the 3D content. The render position may correspond to the position and orientation of a virtual camera in the 3D space of the 3D content, and may define the field-of-view from which to render the 3D content. In some embodiments, the render position may not be specified as part of the request and the 3D content may be presented from a default or initial field-of-view. The 3D content is a 3D scene or 3D environment that includes two or more different 3D assets. The requested 3D content may be a static 3D scene or a frame from a 3D animation, 3D video, 3D game, or spatial computing experience. The 3D assets correspond to 3D models of different objects in the 3D scene or 3D environment.

Dynamic streaming system 100 identifies (at 104) the set of two or more 3D assets that make up the requested 3D content. In some embodiments, the 3D content is associated with a file that lists the set of two or more 3D assets. The file may also specify the position of each 3D asset from the set of two or more 3D assets in a 3D space of the 3D content. Accordingly, the file may define the 3D scene or 3D environment.

Dynamic streaming system 100 selects (at 106) different encoding formats at which to present or stream the set of two or more 3D assets based on their respective depths, positions, and/or sizes in the current field-of-view. The current field-of-view may specified as part of the request. For instance, the request may specify a virtual camera position and/or orientation from which to render the 3D content. Alternatively, the current field-of-view may correspond to a default or initial field-of-view at which the 3D content is rendered.

Selecting (at 106) the different encoding formats includes selecting a 2D image to present or stream first 3D asset 101 that is located at a first depth, at a first position in the periphery, and/or at a first size in the current field-of-view. For instance, first 3D asset 101 may be converted, rendered, and/or otherwise encoded as a Joint Photographic Experts Group (JPEG), Portable Network Graphics (PNG), Graphics Interchange Format (GIF), Tagged Image File Format (TIFF), or other 2D image. The first depth may correspond to a range of z-depth values that are farthest from the render position and/or that correspond to the backmost planes of the current field-of-view. The first position in the periphery may correspond to the borders of the current field-of-view. The first size may correspond to a small percentage of the current field-of-view that is occupied by first 3D asset 101. In some embodiments, dynamic streaming system 100 selects (at 106) the 2D image format when first 3D asset 101 satisfies any of the first depth, first position, or first size conditions. In some other embodiments, dynamic streaming system 100 selects (at 106) the 2D image format based on first 3D asset 101 partly satisfying one or more conditions for the first depth, first position, and/or first size. For instance, dynamic streaming system 100 may select (at 106) the 2D image format for first 3D asset 101 when first 3D asset 101 occupies slightly more than the first size in the current field-of-view, is slightly offset from the first position in the periphery, and is located in plane that is immediately before the first depth. The 2D image format provides first 3D asset 101 at a particular low fidelity or quality with less data than other available encoding formats.

Selecting (at 106) the different encoding formats includes selecting a mesh model representation to present or stream second 3D asset 103 that is located at a second depth, at a second position in the periphery, and/or at a second size in the current field-of-view. The mesh model representation creates the 3D form and structure of second 3D asset 103 via a connected set of meshes or polygons. Each mesh may be defined with a set of vertices to define their position in the 3D space. Each mesh may also be defined with color values and/or a texture may be applied to the mesh to add visual detail to the 3D form or structure. The mesh encoding format provides second 3D asset 103 at a higher fidelity or quality than the 2D image format with less data than other available encoding formats. Specifically, the 2D image format, splat encoding format, and point cloud encoding format may be unable to provide the same fidelity or quality as the mesh encoding format or would require more data to do so.

Selecting (at 106) the different encoding formats includes selecting a splat representation to present or stream third 3D asset 105 that is located at a third depth, at a third position in the periphery, and/or at a third size in the current field-of-view. The splat representation creates the 3D form, structure, and visual appearance of third 3D asset 105 with overlapping and/or semi-transparent splats. The splats may correspond to Gaussian splats or ellipsoids of varying shapes and sizes that are generated by a neural network or iterative artificial intelligence and/or machine learning techniques to represent third 3D asset 105 with a specified amount of quality loss and/or at a specified size. The splat representation is a higher quality, higher fidelity, or more accurate visualization of a 3D asset than the mesh model representation as two or more splats may be overlaid to recreate part of a surface with more visual accuracy than recreating that same surface part with one or more connected meshes. Accordingly, the splat encoding format provides third 3D asset 105 at a higher fidelity or quality than the 2D image encoding format and the mesh encoding format and with less data than other available encoding formats for the same fidelity or quality.

Selecting (at 106) the different encoding formats includes selecting a point cloud representation to present or stream fourth 3D asset 107 that is located at a fourth depth, at a fourth position in the periphery, and/or at a fourth size in the current field-of-view. The point cloud representation creates the 3D form, structure, and visual appearance of fourth 3D asset 107 with a disconnected and distributed set of points. The points and/or point cloud representation provide the highest quality or fidelity for any 3D asset. The points of the point cloud encoding format represent primitives that are typically smaller in size than the splats or meshes of the other encoding formats. The smaller points may be used to capture more detail than the splats or meshes. However, the points and/or point cloud representation require the most amount of data to represent a 3D asset as more points are needed to represent a 3D asset than splats or meshes. Accordingly, the point cloud encoding format may be used to present a 3D asset at a highest fidelity or quality that cannot be matched by the other encoding formats and/or with the same amount of data as the point cloud encoding format.

Dynamic streaming system 100 streams (at 108) the 2D image for first 3D asset 101, the meshes of second 3D asset 103 mesh model, the splats of the third 3D asset 105 splat representation, and the points of fourth 3D asset 107 point cloud representation in response to the received request for the 3D content. The different 3D primitives (e.g., meshes, splats, and points) may be streamed together (e.g., mixed in the streamed data packets) or at different times (e.g., stream the points, then the splats, then the meshes, and then the 2D image). Dynamic streaming system 100 may stream (at 108) the 2D image and the different 3D primitives with positional data. The positional data may specify where in a common 3D space to render or place the 2D image and each of the primitives.

The client device receives the streamed (at 108) data and generates a visual representation for the 3D content by rendering the 2D image, meshes, splats, and/or points and by combining the rendering results. The client device generates a varying resolution representation of the 3D content that contains greater detail at the fourth depth, fourth position, and/or for 3D assets that occupy the fourth size of the field-of-view and with progressively lesser detail for the 3D assets at the third, second, and first depths, positions, and/or sizes. Specifically, 3D assets at the center, in the foreground, and/or that occupy the largest area in the field-of-view have the greatest amount of detail as a result of being rendered from points of a point cloud, and 3D assets that are further from the center, further from the foreground, and/or that occupy smaller and smaller areas in the field-of-view have progressively lesser detail as a result of being rendered with splats, then meshes, and then 2D images based on their increasing depths from the foreground, increasing distances from the center, and decreasing sizes in the field-of-view.

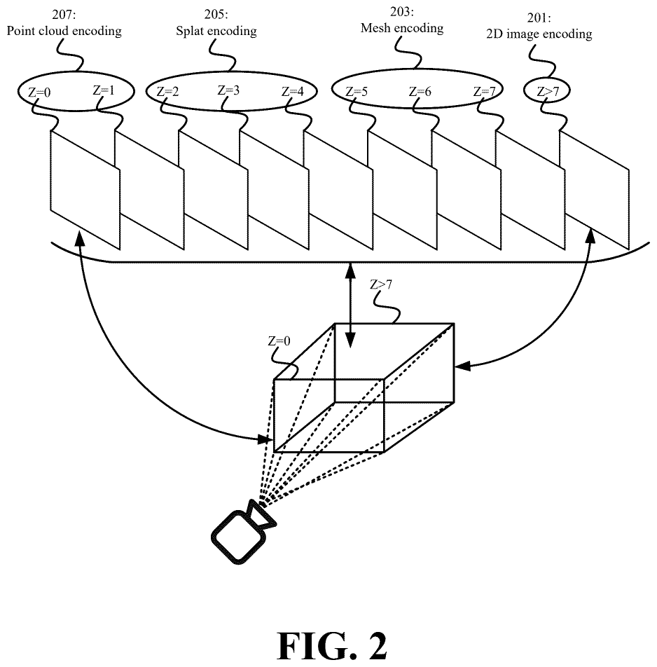

FIG. 2 illustrates an example of the different depths in a 3D scene for selecting and streaming 3D assets in different encoding formats in accordance with some embodiments presented herein. As shown in FIG. 2, a 3D scene or 3D space may be partitioned into four different sets of depth planes including first set of depth planes 201, second set of depth planes 203, third set of depth planes 205, and fourth set of depth planes 207. In some embodiments, the 3D scene or 3D space may be partitioned into more or less depth planes depending on the different available encoding formats for representing and streaming the 3D assets of the 3D content or 3D space.

3D assets that are positioned in one of first set of depth planes 201 that are farthest from the render position and/or farthest in the background may streamed as 2D images. The 2D images preserve a minimal first amount of detail and dimensionality that is consistent with how the human eye views objects that are distant. Moreover, the 2D images provide the first amount of detail and dimensionality with the least amount of data as compared to mesh, splat, and/or point cloud representations of the same 3D asset.

3D assets that are positioned in one of second set of depth planes 203 that are closer to the render position and/or closer in the background than first set of depth planes 201 may be streamed as mesh models. The mesh models provide a second amount of detail and dimensionality that is greater than the first amount of detail and dimensionality. Moreover, the mesh models provide the second amount of detail and dimensionality with less data than the other encoding formats. Accordingly, the mesh encoding format is optimized for streaming 3D assets having the second amount of detail and dimensionality.

3D assets that are positioned in one of third set of depth planes 205 that are closer to the render position than second set of depth planes 203 may streamed as splat representations. The splat representations provide a third amount of detail and dimensionality that is greater than the second amount of detail and dimensionality. Moreover, the detail and dimensionality provided by the splat encoding format is more than the other encoding formats encode with the same amount of data.

3D assets that are positioned in one of fourth set of depth planes 207 that are closest to the render position may be streamed as point clouds. The point cloud representation provides a fourth amount of detail and dimensionality that is greater than the third amount of detail and dimensionality and/or detail and dimensionality than the other encoding formats encode with the same amount of data.

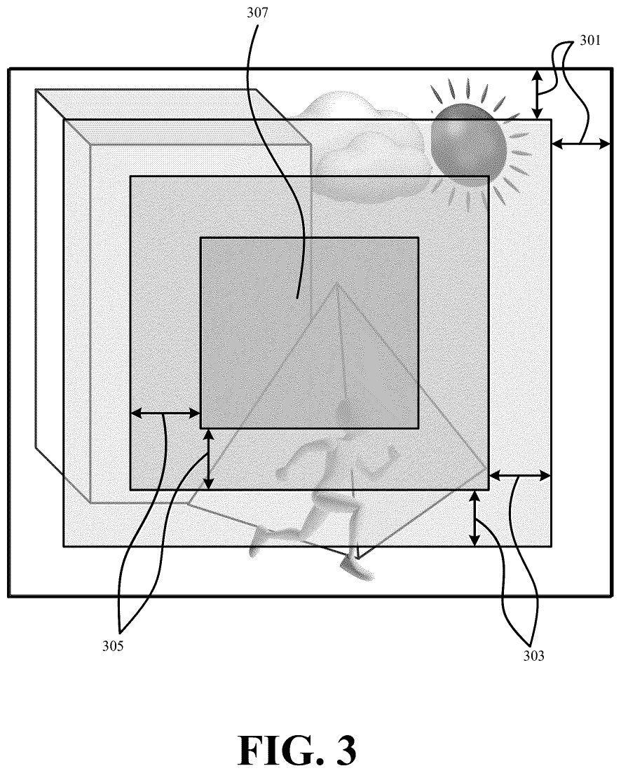

FIG. 3 illustrates an example of associating different positions in a 3D scene with different encoding formats in accordance with some embodiments presented herein. As shown in FIG. 3, a 3D scene or 3D space may be partitioned into four different regions including first regions 301, second regions 303, third regions 305, and fourth regions 307. In some embodiments, the 3D scene or 3D space may be partitioned into more or less regions depending on the different available formats for representing and streaming the 3D assets of the 3D or 3D space.

First regions 301 represent the border or peripheral regions of the field-of-view. Second regions 303 represent regions adjacent to the border or peripheral areas that are closer to the field-of-view center than first regions 301. Third regions 305 represent regions adjacent to second regions 303 that are still closer to the field-of-view center than second regions 303. Fourth regions 307 represent regions at and surrounding the field-of-view center.

Dynamic streaming system 100 selects the lowest quality or fidelity encoding format that uses the least amount of data (e.g., the 2D image format) for streaming 3D assets located in first regions 301, selects a second encoding format (e.g., a mesh model) that is optimized for encoding 3D assets located in second regions 303 at a higher second quality or fidelity than the lowest quality or fidelity format, selects a third encoding format (e.g., splat representations) that is optimized for encoding 3D assets located in third regions 305 at a higher third quality or fidelity than the second encoding format, and selects a fourth format (e.g., point clouds) that is optimized for encoding 3D assets located in fourth regions 307 at the highest quality or fidelity. Each encoding format is optimized to encode 3D assets at a different quality or fidelity range with less data than the other encoding formats. Encoding the 3D assets outside those different quality or fidelity ranges may result in a representation or encoding that uses more data for the same quality of fidelity than another encoding format that is optimized for that quality or fidelity range.

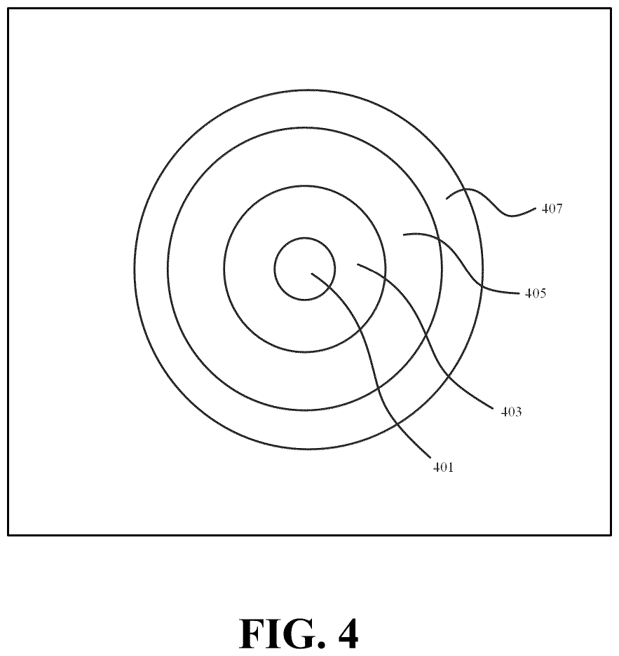

FIG. 4 illustrates an example of the different sizes of occupied areas in a 3D scene for selecting and streaming 3D assets in different encoding formats in accordance with some embodiments presented herein. 3D assets that occupy smallest first sized regions 401 in the field-of-view are streamed with the lowest quality or fidelity encoding format that uses the least amount of data (e.g., the 2D image format). 3D assets that occupy second sized regions 403 in the field-of-view that are larger than first sized regions 401 are streamed using the second encoding format. 3D assets that occupy third sized regions 405 in the field-of-view that are larger than second sized regions 403 are streamed using the third encoding format. 3D assets that occupy largest sized regions 407 in the field-of-view are streamed using the fourth encoding format.

Dynamic streaming system 100 may dynamically adjust the encoding format that is used to stream different 3D assets as the 3D assets move at different times or within different frames of the field-of-view. The dynamic adjustment includes changing between the encoding formats such that the increase or decrease in the visual quality or fidelity of the 3D asset is unnoticeable or seamless to the viewer.

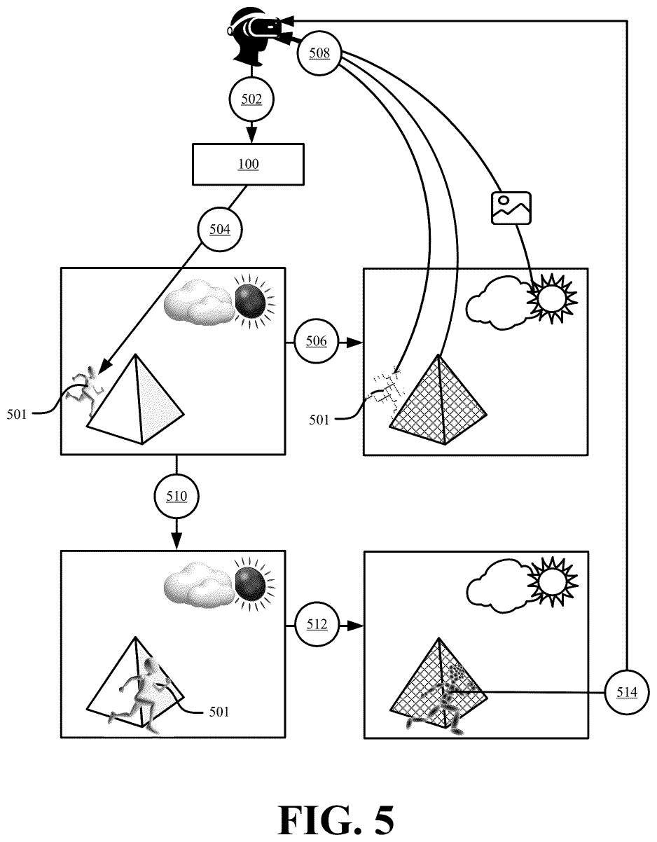

FIG. 5 illustrates an example of dynamically adjusting the encoding format at which a 3D asset is streamed based on changes to the 3D asset in a field-of-view in accordance with some embodiments presented herein. Dynamic streaming system 100 receives (at 502) a request to stream 3D content to a client device.

Dynamic streaming system 100 determines (at 504) that the 3D content includes 3D asset 501 that is initially positioned in the background and towards the periphery of the initial field-of-view and occupies a first amount of the initial field-of-view. In some embodiments, dynamic streaming system 100 determines (at 504) the depth, position, and/or size of 3D asset 501 based on a 3D content definition file that specifies the arrangement of the 3D content assets in a 3D space relative to a render position. In some other embodiments, dynamic streaming system 100 determines (at 504) the depth, position, and/or size of 3D asset 501 by rendering the 3D content or by entering the 3D assets into a 3D space as defined in programming, code, metadata, or other instructions associated with the 3D content.

Based on one or more of the depth, positioning, and size of 3D asset 501, dynamic steaming system 100 selects (at 506) to stream 3D asset 501 in a first encoding format to the client device. In this example, the first encoding format corresponds to a mesh representation or mesh model of 3D asset 501. The selection (at 506) of the first encoding format is based on an amount of detail that is resolvable for an object at the depth, position, and size in the initial field-of-view as 3D asset 501 and the first encoding format is optimized to provide that amount of detail with the least amount of data.

In some embodiments, dynamic streaming system 100 generates the mesh representation for 3D asset 501 by converting a highest quality point cloud representation of 3D asset 501 to the mesh representation. For instance, dynamic streaming system 100 may use a subset of the points from the point cloud representation to become vertices for meshes and may replace all points in between the selected vertices with a mesh. By selecting which points to use as the mesh vertices, dynamic streaming system 100 may control the level of quality or fidelity and the amount of data that is encoded in the mesh representation of 3D asset 501. Specifically, dynamic streaming system 100 may define the meshes to optimize the fidelity-to-size ratio of the mesh representation and/or to specify a desired fidelity for the depth, position, and/or size of 3D asset 501 in the initial field-of-view at a total size that is less than the other encoding formats generate for that same desired fidelity.

Dynamic streaming system 100 streams (at 508) the primitives (e.g., meshes) that define the 3D structure and visual characteristics of 3D asset 501 at a first amount of detail or fidelity and with a first total amount of data in the first encoding format to the client device. Dynamic streaming system 100 streams (at 508) other 3D assets in the same or other encoding formats to provide the client device with the data for rendering the initial field-of-view. The client device receives the streamed data for 3D asset 501 and/or other 3D assets in the initial field-of-view, uses a rendering engine to generate a visual representation of the initial field-of-view from the streamed data, and presents the visual representation on a display.

Dynamic streaming system 100 tracks (at 510) changes to the field-of-view. The field-of-view changes may include changes to the depth, position, and/or size of the 3D assets. The field-of-view may change in response to user input that changes where the user is looking. For instance, the user input may change the position and/or orientation of a virtual camera or the render position for the field-of-view. The user input may also manipulate 3D asset 501 when 3D asset 501 is a playable or interactive character in a 3D game or when 3D asset 501 is an interactive element in the 3D game. The field-of-view may also change in response to programmed changes to 3D asset 501. The programmed changes may include animations, physics, forces, and/or movements that are applied to 3D asset 501 over time.

In some embodiments, dynamic streaming system 100 tracks (at 510) the field-of-view changes at every rendered frame. In some other embodiments, dynamic streaming system 100 tracks (at 510) the field-of-view changes at specific key frames. The key frames may include frames in a animation or video where all scene data is streamed to the client device. For instance, the key frames may include every fifth frame or frames in an animation or dynamic 3D content where there is significant change from one frame to the next. For the frames that are in between the key frames, dynamic streaming system 100 may retain the encoding format that was selected for the 3D assets at the last key frame and may stream updates to the 3D assets. The updates may include formulas, transformations, and/or other changes that the client device applies to manipulate the 3D asset. The updates may also include instructions to remove or move one or more primitives of a particular 3D asset that were already streamed with a last key frame and/or add on or more primitives to render with the existing primitives of the particular 3D asset.

Dynamic streaming system 100 determines that 3D asset 501 has moved closer to the foreground and center and occupies a larger size of the current field-of-view based on the tracking (at 510). Since 3D asset 501 has become more visible and its details are more resolvable in the current field-of-view, dynamic steaming system 100 selects (at 512) to stream 3D asset 501 in a second encoding format to the client device. The second encoding format is different than the first encoding format and may correspond to a splat representation of 3D asset 501. Dynamic streaming system 100 may generate the splat representation for 3D asset 501 by converting a highest quality point cloud representation of 3D asset 501 to the splat representation or by using the point cloud representation to iteratively generate the splats for the splat representation at the desired quality or fidelity and with a desired amount of loss and size reduction relative to the point cloud representation.

The splat representation for 3D asset 501 is at a higher fidelity and/or has more detail than the mesh representation for 3D asset 501. More data may be needed to encode the splat representation than the mesh representation. However, upscaling the mesh representation of 3D asset 501 to match the higher fidelity and/or detail of the splat representation would require even more data. In other words, as the fidelity and/or quality of 3D asset 501 increases, the second encoding format encodes the increased fidelity and/or quality more efficiently and with less data than the first encoding format.

Dynamic streaming system 100 streams (at 514) the splat representation of 3D asset 501 for the current field-of-view to the client device. In some embodiments, dynamic streaming system 100 does not restream the data for other 3D assets that did not change from the initial field-of-view to the current field-of-view or may stream only positional updates to the other 3D assets if the changed positions do not trigger an upscaling or downscaling to the quality or fidelity of the other 3D assets.

The client device receives the streamed data for the current field-of-view, renders the streamed data, and presents an updated visualization for the current field-of-view, wherein the updated visualization moves 3D asset 501 closer to the foreground and center to occupy a larger size and presents 3D asset 501 with the additional fidelity and/or detail of the second encoding format. The transition of 3D asset 501 from the first encoding format to the second encoding format is seamless. The viewer may notice that the rendered visualization of 3D asset 501 gains visual detail as would be expected for an object that moves closer to the viewer. However, the mesh representation and the splat representation of 3D asset 501 are nevertheless rendered as pixels to present on a display and more pixels are used to present the additional detail of 3D asset 501 as it moves closer to the field-of-view foreground and/or center.

In some embodiments, dynamic streaming system 100 factors the network performance as part of the determination of which encoding format to use when streaming different 3D assets in a requested field-of-view or scene. Higher network performance allows dynamic streaming system 100 to stream more 3D assets that may be located further in the background, in the periphery, or occupying smaller sized regions of the field-of-view using higher fidelity encoding formats (e.g., point clouds or splat representations). Similarly, lower network performance restricts the number of 3D assets that may be streamed using the higher fidelity encoding formats even when those 3D assets may be located in the field-of-view foreground, center, or at a large size.

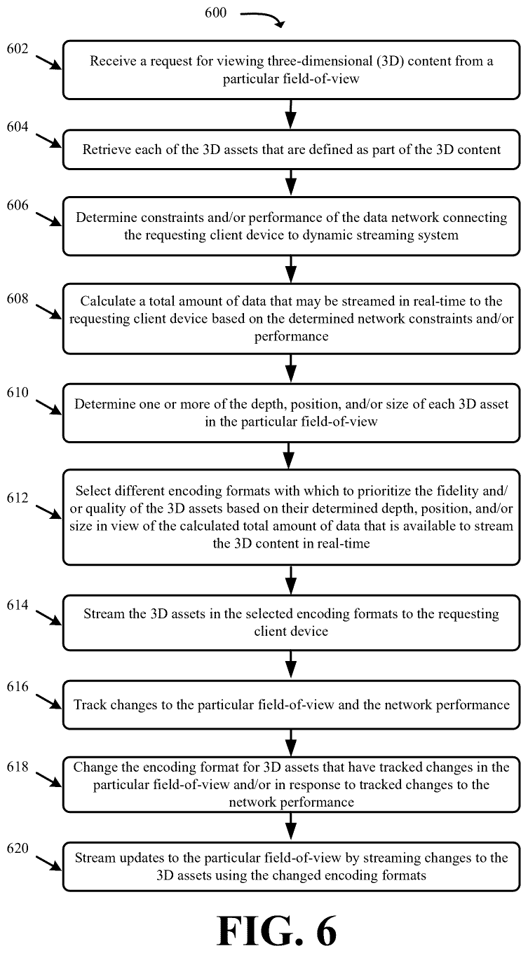

FIG. 6 presents a process 600 for dynamically streaming 3D assets using different formats based on network performance and 3D asset placement in the field-of-view in accordance with some embodiments presented herein. Process 600 is implemented by dynamic streaming system 100.

Dynamic streaming system 100 includes one or more devices, machines, or servers with processor, memory, storage, network, and/or other hardware resources that are configured to distribute 3D content with varying fidelity over a data network in real-time and/or without buffering to different requesting client devices. Dynamic streaming system 100 may be part of a video, game, spatial computing, or other 3D streaming service.

Process 600 includes receiving (at 602) a request for viewing 3D content from a particular field-of-view. The 3D content may be a static 3D environment, a video or animation, an interactive game, a spatial computing experience (e.g., virtual reality, mixed reality, augmented reality, etc.), and/or other static or dynamic 3D experiences. The 3D content may be defined with multiple different 3D assets. The 3D assets may correspond to models or representations of different characters, objects, and/or visual elements that collectively form the 3D content.

The request may be issued by a client device. The client device may remotely access different 3D content or 3D experiences from dynamic streaming system 100 over a data network that may have varying performance based on the client device location, congestion on the data network, total available bandwidth, hops separating the client device and dynamic streaming system 100, and/or other network factors or conditions. The client device has processor, memory, storage, network, and/or other hardware resources for receiving the 3D assets of the 3D content encoded in different formats and for rendering the different formats to produce a unified or single visualization of the 3D content.

Process 600 includes retrieving (at 604) each of the 3D assets that are defined as part of the 3D content. In some embodiments, dynamic streaming system 100 stores and retrieves (at 604) the highest quality representation for each of the 3D assets. For instance, dynamic streaming system 100 may retrieve (at 604) a point cloud representation for each 3D asset of the 3D content. Dynamic streaming system 100 may generate the other lower quality representations or other encoding formats from the highest quality representation using an encoding or conversion technique that converts the point cloud representation to a splat representation, a mesh representation, and a 2D image. In some other embodiments, dynamic streaming system 100 stores and retrieves (at 604) the different format encodings for the 3D assets from a database or other data store associated with the 3D content. In some such embodiments, the different format encodings may be generated by the 3D content originator or dynamic streaming system 100 prior to making the 3D content available for streaming.

Process 600 includes determining (at 606) constraints and/or performance of the data network connecting the requesting client device to dynamic streaming system 100. Dynamic streaming system 100 may determine (at 606) the network performance by using pings, connection establishment packets, or test packets to determine the latency, bandwidth, congestion, jitter, packet loss, and/or other network performance characteristics for the connection or link between the requesting client device and dynamic streaming system 100.

Process 600 includes calculating (at 608) a total amount of data that may be streamed in real-time to the requesting client device based on the determined (at 606) network constraints and/or performance. The total amount of data may correspond to the data for streaming the 3D content or other content to the client device at a desired frame rate without buffering or visual interruptions.

Process 600 includes determining (at 610) one or more of the depth, position, and/or size of each 3D asset in the particular field-of-view. The 3D asset depth, position, and/or size is determined (at 610) based on a defined position of each 3D asset in the 3D space of the 3D content relative to a position and/or orientation of a virtual camera and/or render position in the 3D space. For instance, the render position may be defined with a first (x, y, z) coordinate and each 3D asset may be defined with a different (x, y, z) coordinate in the same 3D space. The size of the 3D assets is based on a percentage or amount of the particular field-of-view that each 3D asset occupies. 3D assets in the background that are partially obscured by one or more other 3D assets have a reduced visible size due to the obstructions.

Process 600 includes selecting (at 612) different encoding formats with which to prioritize the fidelity and/or quality of the 3D assets based on their determined (at 610) depth, position, and/or size in view of the calculated (at 608) total amount of data that is available to stream the 3D content in real-time. The selection (at 612) includes selecting encoding formats that are optimized for the highest and/or higher fidelities for the 3D assets that occupy the largest regions of the particular field-of-view foreground and center and selecting encoding formats that are optimized for progressively lower fidelities for the 3D assets that occupy progressively smaller regions of the particular field-of-view that are farther from the foreground and center such that the total amount of data for the 3D assets encoded in the selected encoding formats is equal to or less than the calculated (at 608) total amount of data for the real-time streaming of the 3D content. In other words, dynamic streaming system 100 modifies which encoding formats and level-of-detail or fidelity are used to encode 3D assets at the different depths, positions, and/or sizes to ensure that the total size of the encoded 3D assets is within the real-time streaming total amount. Accordingly, if the total amount of data is large due to greater bandwidth availability, dynamic streaming system 100 may upscale and stream 3D assets that are farther from the field-of-view center and foreground using the higher fidelity encoding formats. If the total amount of data is small due to low bandwidth availability, dynamic streaming system 100 may downscale and stream 3D assets that are closer to the field-of-view center and foreground using the progressively lower fidelity encoding formats.

Process 600 includes streaming (at 614) the 3D assets in the selected (at 612) encoding formats to the requesting client device. The streaming (at 614) includes distributing different 3D primitives for the 3D assets that are encoded in the different encoding formats. For instance, dynamic streaming system 100 streams (at 614) point data for a first 3D asset that is streamed at a highest quality point cloud representation and streams (at 614) mesh data for a second 3D asset that is streamed at a next-to-lowest quality mesh representation. The point data may include an (x, y, z) coordinate position and visual characteristic values (e.g., color values, transparency, reflectivity, etc.) for each point. The mesh data may include three or more (x, y, z) coordinate positions for the vertices of each mesh and visual characteristic values for the plane spanned by the mesh. Splat data may include (x, y, z) coordinates, a scaling value for the radius or shape of the splat, orientation or rotational information, a covariance matrix, and/or spherical harmonics that represent the visual characteristics of the splat. For 3D assets that are streamed as 2D images, dynamic streaming system 100 may generate a 2D image by rendering primitives from a 3D format encoding of the 3D asset and may stream the 2D image in place of the primitives.

Process 600 includes tracking (at 616) changes to the particular field-of-view and the network performance. Changes to the particular field-of-view may be caused by user inputs that move or interact with various 3D assets of the 3D content or that change the virtual camera or render position. Changes to the particular field-of-view may also be caused by programmed animations or movements, recorded virtual camera movements, and/or recorded movements for a 3D video. For instance, the particular field-of-view may be updated 30 times a second for an animation or video even when none of the 3D assets change.

Process 600 includes changing (at 618) the encoding format for 3D assets that have tracked (at 616) changes in the particular field-of-view and/or in response to tracked (at 616) changes to the network performance. Changing (at 618) the encoding format may include upscaling or downscaling the 3D assets by switching between the 2D image encoding, mesh encoding, splat encoding, point cloud encoding, and/or other 3D encoding formats of the 3D assets as the particular field-of-view changes or is updated in different frames of an animation or video. In particular, dynamic streaming system 100 may change (at 618) the encoding format for 3D assets that move a threshold amount closer to or farther from the field-of-view center or foreground and/or that occupy a threshold amount more or less of the field-of-view. Tracked changes to the network performance may increase or decrease the total amount of data that may be streamed to the client device in real-time and may also cause changes (at 618) to the encoding format.

Process 600 includes streaming (at 620) updates to the particular field-of-view by streaming changes to the 3D assets using the changed (at 618) encoding formats. For instance, dynamic streaming system 100 may initially stream (at 614) a first 3D asset of the 3D content as a 2D image and a second 3D asset of the 3D content as a point cloud, and may stream (at 620) updates to the particular field-of-view that include streaming the first 3D asset as a mesh representation due to increased network performance and/or the first 3D asset moving closer to the foreground and/or center of the particular field-of-view and streaming the second 3D asset as a splat representation due to decreased network performance and/or the second 3D asset moving farther from the particular field-of-view foreground and center.

Dynamic streaming system 100 may also account for the rendering performance of the requesting client device in selecting and determining when to switch the encoding format used to stream the different 3D assets. The rendering performance corresponds to the resources that the requesting client device has to render the streamed 3D content. The resources may include the compute and Graphics Processing Unit (GPU) resources that the rendering engine and/or rendering pipeline of the requesting client device uses to process and render the streamed data.

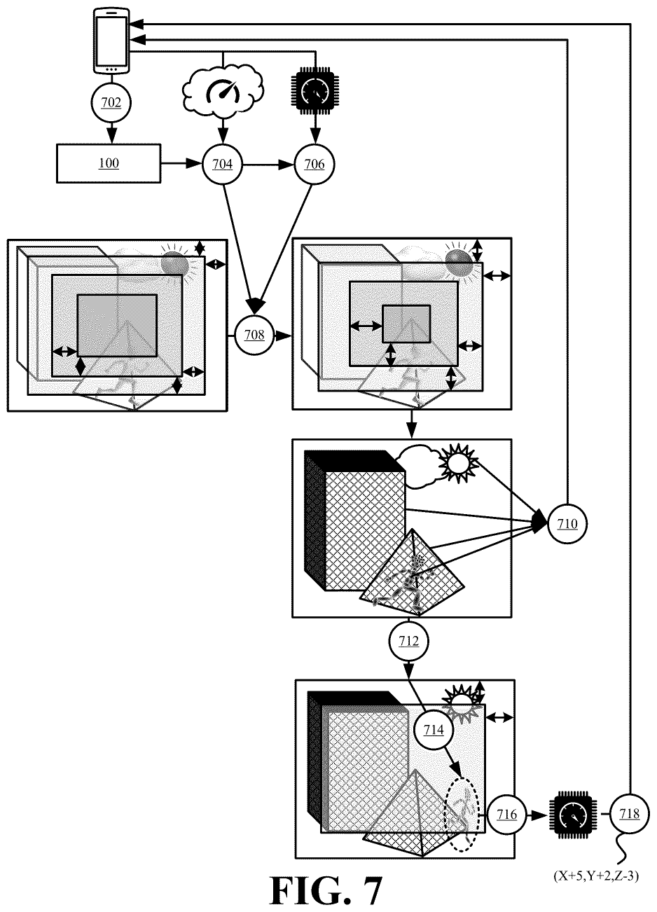

FIG. 7 illustrates an example of dynamically adjusting the streaming format for 3D assets based on the rendering performance of a requesting client device in accordance with some embodiments presented herein. Dynamic streaming system 100 receives (at 702) a request to stream 3D content from a field-of-view to a requesting client device.

Dynamic streaming system 100 monitors (at 704) network performance and determines (at 706) the rendering performance of the client device. Dynamic streaming system 100 may determine (at 706) the rendering performance based on header values in the packets sent by the client device. The header values may identify the device type (e.g., make and model) and/or various hardware resources of the device (e.g., GPU model). Alternatively, the request may specify a desired level-of-detail that the client device supports.

Dynamic streaming system 100 modifies (at 708) which encoding formats are used to perform the prioritized fidelity and/or quality encoding of 3D assets at different depths, positions, and/or sizes of the field-of-view such that the entirety of the encoded 3D content fits within the real-time streaming envelope that is determined from the network performance and the real-time rendering envelope that is determined from the rendering performance of the client device.

Dynamic streaming system 100 streams (at 710) the 3D assets for the requested content with the different encoding formats to ensure that the streamed 3D content fits within the real-time streaming envelope that is determined from the network performance and the real-time rendering envelope that is determined from the rendering performance of the client device. For instance, there may be sufficient network bandwidth to stream all 3D assets using the highest fidelity format (e.g., point clouds). However, the client device may not have enough rendering performance to render all 3D assets in the highest fidelity format as doing so may cause the client device to drop frames, skip rendering parts of the 3D content, or present the 3D content at a reduced frame rate.

Dynamic streaming system 100 tracks (at 712) changes to the field-of-view and/or network performance, and determines (at 714) that one of the 3D assets may be downscaled to an encoding format that is optimized for a lower fidelity based on the tracked (at 712) changes. For instance, the 3D asset may move from the foreground and/or center to the background and/or periphery of the field-of-view.

Dynamic streaming system 100 determines (at 716) that the rendering performance of the client device is maximized and/or is past a threshold (e.g., the client device resources exceed 80% usage). Accordingly, streaming the 3D asset in a different encoding format with all new primitives may impose additional processing and/or rendering overhead on the client device. To preserve and/or reduce the rendering resources, dynamic streaming system 100 does not change the encoding format for the 3D asset since the client device already has the primitives for the 3D asset in the last encoding format in memory. Instead, dynamic streaming system streams (at 718) positional changes or transformations that the client device may apply to the 3D asset without having to render different primitives of the 3D asset in a different encoding format. In other words, the client device reuses the data it already has received for the 3D asset and/or the previously rendered visualization of the 3D asset when presenting the 3D asset in an updated field-of-view or a new frame of animation.

In some embodiments, dynamic lighting techniques, such as ray-tracing, may be applied and/or supported as part of the dynamic streaming of 3D assets in the different formats. The lighting information may be streamed separate from the 3D content data or primitives or may be computed locally on the client device when rendering the 3D content.

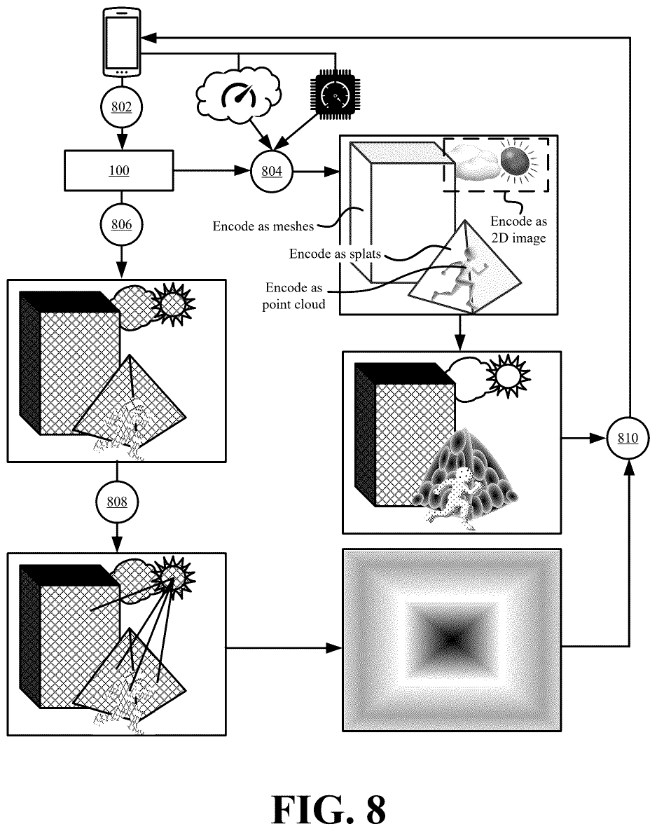

FIG. 8 illustrates an example for dynamic lighting of a scene that is generated from 3D assets encoded in different encoding formats in accordance with some embodiments presented herein. Dynamic streaming system 100 receives (at 802) a request for a 3D scene or 3D environment from a particular field-of-view.

Dynamic streaming system 100 selects (at 804) different encoding formats with which to stream the data or primitives for the set of 3D assets in the 3D scene or the 3D environment. The selection of the different formats for the set of 3D assets may be based on one or more of the 3D asset depth, position, and size in the 3D scene or the 3D environment, network performance, and/or rendering performance.

Dynamic streaming system 100 retrieves (at 806) a lowest fidelity and lowest size 3D encoding for the set of 3D assets. For instance, dynamic streaming system 100 may retrieve (at 806) each of the set of 3D assets as a low resolution mesh model.

Dynamic streaming system 100 dynamically lights (at 808) the 3D scene or the 3D environment using the lowest fidelity and lowest size 3D encoding for the set of assets. Dynamically lighting (at 808) the 3D scene may include generating the 3D scene by placing the set of 3D assets in their designated positions, locating one or more light sources defined for the 3D scene, and performing ray-tracking and/or other lighting techniques to illuminate the 3D scene and determine the shading, shadows, highlights, lowlights, brightness, and other lighting attributes for each 3D asset. In some embodiments, dynamic streaming system 100 generates a light texture for each 3D asset. The light texture is a file that maps the lighting attributes off the 3D surface of a 3D asset to a 2D format. In some other embodiments, dynamic streaming system 100 defines an array, matrix, or other data structure that maps the lighting attributes to specific coordinate position about a 3D asset.

Dynamic streaming system 100 streams (at 810) the different format encodings selected (at 804) for the set of 3D assets with the lighting texture or lighting values computed for each 3D asset to the client device. The client device may generate the 3D forms, structures, and visual characteristics of each 3D asset based on the primitives or data in the different format encodings, and may apply the lighting texture or lighting values to the generated 3D forms, structure, and visual characteristics. For instance, the client device may adjust the lighting at a particular pixel or point on a 3D asset by mapping the values in the lighting texture to different pixels or points about the 3D asset and determining the particular value in the light texture that is defined at a position in the lighting texture that corresponds to the particular pixel or point on the 3D asset.

In some embodiments, dynamic streaming system 100 streams (at 810) the different format encodings selected (at 804) for the set of 3D assets without any lighting information or data. In some such embodiments, the client device renders the data or primitives for the streamed 3D assets to generate an unlit representation of the 3D scene or 3D environment. The client device may then dynamically light the 3D scene or 3D environment by performing ray-tracing or other lighting techniques on the generated structures, forms, and visual characteristics.

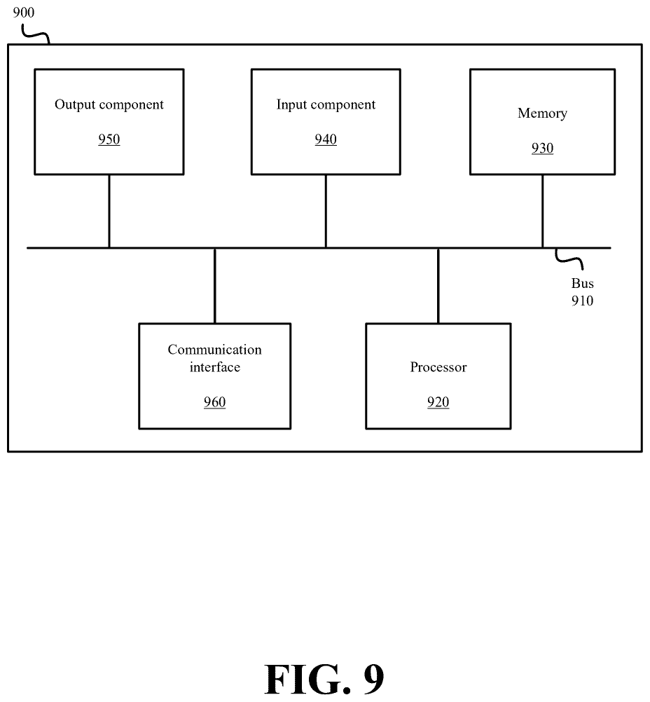

FIG. 9 is a diagram of example components of device 900. Device 900 may be used to implement one or more of the tools, devices, or systems described above (e.g., dynamic streaming system 100, client device, etc.). Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more LEDs, etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise. This listing of claims will replace all prior versions and listings of claims in the application. The following listing provides the amended claims with deleted material crossed out and new material underlined to show the changes made.

1. A method comprising:
receiving a single request for three-dimensional (3D) content from a client at a streaming system, wherein the 3D content comprises a first 3D asset and a second 3D asset, and wherein the single request does not specify an encoding format for the first 3D asset or the second 3D asset;
retrieving, at the streaming system, a file specifying a first position of the first 3D asset and a second position of the second 3D asset in a 3D space of the 3D content without providing a manifest for the 3D content from the streaming system to the client in response to the single request;
determining, at the streaming system, one or more of a first depth, proximity to a center position, or size of the first 3D asset within a current field-of-view of the 3D content and one or more of a second depth, proximity to the center position, or size of the second 3D asset within the current field-of-view of the 3D content based on the first position and the second position specified in the file;
selecting, at the streaming system, a splat representation encoding for the first 3D asset and the an encoding format that is different than the splat representation for the second 3D asset based on the one or more of the first depth, proximity to the center position, or size being associated with a first amount of detail that is optimally encoded with the splat representation and based on the one or more of the second depth, proximity to the center position, or size being associated with a second amount of detail that is optimally encoded with the encoding format;
encoding, at the streaming system, the first 3D asset with a plurality of splats that represent the first 3D asset with the first amount of detail and the second 3D asset with primitives of the encoding format that are different than splats and that represent the second 3D asset with the second amount of detail; and
generating a single visual representation for the 3D content in the current field-of-view by streaming the plurality of splats for the first 3D asset with the primitives for the second 3D asset from the streaming system to the client in response to the single request.

2. (canceled)

3. The method of claim 1, wherein said determining comprises:
identifying, from the single request, a render position that establishes the current field-of-view; and
computing a depth and the proximity to the center position for each of the first 3D asset and the second 3D asset relative to the render position.

4. The method of claim 1, wherein selecting the encoding format for the second 3D asset comprises:
selecting the encoding format to be a two-dimensional (2D) image or a mesh representation based on the second 3D asset being located in a background or periphery of the current field-of-view; and
selecting the encoding format to be a point cloud representation based on the second 3D asset being located in a foreground or center of the current field-of-view.

5. The method of claim 1, wherein said selecting comprises:
selecting the splat representation for the first 3D asset in response to the splat representation being optimized to encode 3D assets at a first range of fidelities with less data than other encoding formats and based on the one or more of the first depth, proximity to the center position, or size of the first 3D asset mapping to the first range of fidelities; and
selecting the encoding format for the second 3D asset in response to the encoding format being optimized to encode 3D assets at a different second range of fidelities with less data than other encoding formats and based on the second one or more of the depth, proximity to the center position, or size of the second 3D asset mapping to the second range of fidelities.

6. The method of claim 1, wherein encoding the second 3D asset with the primitives comprises:
encoding the second 3D asset as a set of meshes or as a set of points.

7. The method of claim 1, wherein said selecting comprises:
selecting the splat representation for the first 3D asset in response to the first 3D asset being positioned in a first set of depth planes of the current field-of-view; and
selecting the encoding format for the second 3D asset in response to the second 3D asset being positioned in a second set of depth planes of the current field-of-view.

8. The method of claim 1, wherein said selecting comprises:
selecting the splat representation for the first 3D asset in response to the first 3D asset being positioned a first set of distances from a center of the current field-of-view; and
selecting the encoding format for the second 3D asset in response to the second 3D asset being positioned a second set of distances from the center of the current field-of-view.

9. The method of claim 1, wherein said selecting comprises:
selecting the splat representation for the first 3D asset in response to the first 3D asset having one of a first set of sizes in the current field-of-view; and
selecting the encoding format for the second 3D asset in response to the second 3D asset having one of a second set of sizes in the field-of-view.

10. The method of claim 1 further comprising:
tracking changes to the second 3D asset after a first field-of-view or a first frame;
determining that the second 3D asset has moved closer to a center or a foreground in response to tracking the changes;
reencoding the second 3D asset as a new splat representation; and
streaming the second 3D asset encoded as the new splat representation for presentation in a second field-of-view or a second frame.

11. The method of claim 10, wherein the new splat representation encodes the second 3D asset with a greater rate of fidelity to amount of data than the encoding format.

12. The method of claim 1,
wherein encoding the first 3D asset with the plurality of splats comprises:
retrieving an encoding of the first 3D asset in a second encoding format; and
converting the encoding of the first 3D asset in the second encoding format to the splat representation, wherein the encoding in the second encoding format has a greater fidelity than the splat representation; and
wherein encoding the second 3D asset with the primitives comprises:
retrieving an encoding of the second 3D asset in the second encoding format; and
converting the encoding of the second 3D asset in the second encoding format to the encoding in the encoding format.

13. The method of claim 1 further comprising:
determining performance of a data network that is used to stream the first 3D asset and the second 3D asset;
determining a total amount of data for a real-time streaming of the 3D content based on the performance of the data network; and
selecting the first encoding format for the first 3D asset and the second encoding format for the second 3D asset based on total data associated with the first 3D asset encoded in the first encoding format and the second 3D asset encoded in the second encoding format being equal to or less than the total amount of data for the real-time streaming of the 3D content.

14. A dynamic streaming system comprising:
one or more hardware processors configured to:
receive a single request for three-dimensional (3D) content from a client, wherein the 3D content comprises a first 3D asset and a second 3D asset, and wherein the single request does not specify an encoding format for the first 3D asset or the second 3D asset;
retrieve a file specifying a first position of the first 3D asset and a second position of the second 3D asset in a 3D space of the 3D content without providing a manifest for the 3D content to the client in response to the single request;
determine one or more of a first depth, proximity to a center position, or size of the first 3D asset within a current field-of-view of the 3D content and one or more of a second depth, proximity to the center position, or size of the second 3D asset within the current field-of-view of the 3D content based on the first position and the second position specified in the file;
select splat representation encoding for the first 3D asset and an encoding format that is different than the splat representation for the second 3D asset based on the one or more of the first depth, proximity to the center position, or size being associated with a first amount of detail that is optimally encoded with the splat representation and based on the one or more of the second depth, proximity to the center position, or size being associated with a second amount of detail that is optimally encoded with the encoding format;
encode the first 3D asset with a plurality of splats that represent the first 3D asset with the first amount of detail and the second 3D asset with primitives of the encoding format that are different than splats and that represent the second 3D asset with the second amount of detail; and
generate a single visual representation for the 3D content in the current field-of-view by streaming the plurality of splats for the first 3D asset with the primitives for the second 3D asset from the streaming system to the client in response to the single request.

15. (canceled)

16. The dynamic streaming system of claim 14, wherein said determining comprises:
identifying, from the single request, a render position that establishes the current field-of-view; and
computing a depth and the proximity to the center position for each of the first 3D asset and the second 3D asset relative to the render position.

17. The dynamic streaming system of claim 14, wherein selecting the encoding format for the second 3D asset comprises:
select the encoding format to be a two-dimensional (2D) image or a mesh representation based on the second 3D asset being located in a background or periphery of the current field-of-view; and
select the encoding format to be a point cloud representation based on the second 3D asset being located in a foreground or center of the current field-of-view.

18. The dynamic streaming system of claim 14, wherein said selecting comprises:
select the splat representation for the first 3D asset in response to the splat representation being optimized to encode 3D assets at a first range of fidelities with less data than other encoding formats and based on the one or more of the first depth, proximity to the center position, or size of the first 3D asset mapping to the first range of fidelities; and
select the encoding format for the second 3D asset in response to the encoding format being optimized to encode 3D assets at a different second range of fidelities with less data than other encoding formats and based on the second one or more of the depth, proximity to the center position, or size of the second 3D asset mapping to the second range of fidelities.

19. The dynamic streaming system of claim 14, wherein
encoding the second 3D asset with the primitives comprises:
encoding the second 3D asset as a set of meshes or as a set of points.

20. A non-transitory computer-readable medium storing instructions that, when executed by one or more processors of a dynamic streaming system, cause the dynamic streaming system to perform operations comprising:
receiving a single request for three-dimensional (3D) content from a client at a streaming system, wherein the 3D content comprises a first 3D asset and a second 3D asset, and wherein the single request does not specify an encoding format for the first 3D asset or the second 3D asset;
retrieving, at the streaming system, a file specifying a first position of the first 3D asset and a second position of the second 3D asset in a 3D space of the 3D content without providing a manifest for the 3D content from the streaming system to the client in response to the single request;
determining one or more of a first depth, proximity to a center position, or size of the first 3D asset within a current field-of-view of the 3D content and one or more of a second depth, proximity to the center position, or size of the second 3D asset within the current field-of-view of the 3D content based on the first position and the second position specified in the file;
selecting a splat representation encoding for the first 3D asset and an encoding format that is different than the splat representation for the second 3D asset based on the one or more of the first depth, proximity to the center position, or size being associated with a first amount of detail that is optimally encoded with the splat representation and based on the one or more of the second depth, proximity to the center position, or size being associated with a second amount of detail that is optimally encoded with the encoding format;
encoding the first 3D asset with a plurality of splats that represent the first 3D asset with the first amount of detail and the second 3D asset with primitives of the encoding format that are different than splats and that represent the second 3D asset with the second amount of detail; and
generating a single visual representation for the 3D content in the current field-of-view by streaming the plurality of splats for the first 3D asset and with the primitives for the second 3D asset from the streaming system to the client in response to the single request.

21. The method of claim 1 further comprising:
determining, at the streaming system, one or more of a third depth, proximity to the center position, or size of a third 3D asset that is part of the 3D content;
selecting, at the streaming system, to encode the third 3D asset as a 2D image based on the one or more of the third depth, proximity to the center position, or size being associated with a third amount of detail that is less than the first amount of detail and the second amount of detail;
encoding, at the streaming system, the third 3D asset as a plurality of pixels of the 2D image that are determined from a rendered visualization of the third 3D asset; and
wherein said streaming comprises streaming the 2D image with the plurality of splats and the primitives in response to the single request.

22. The method of claim 1, wherein said streaming comprises:
streaming the plurality of splats for a first set of frames of an animation associated with the 3D content;
retaining the splat representation as an encoding format for the first 3D asset across the first set of frames until a next key frame;
detecting the next key frame of the animation that is after the first set of frames and at which all data associated with the current field-of-view for the 3D content is streamed to the client;
changing an encoding of the first 3D asset from the plurality of splats to a plurality of meshes for a mesh representation of the first 3D asset; and
streaming the plurality of meshes at the next key frame and for a second set of frames of the animation after the next key frame.
